(19) United States
(12) Patent Application Publication
(10) Pub. No.: US 2006/0062093 A1
(43) Pub. Date: Mar. 23, 2006

(54) Track-seeking for optical pick-up unit with dynamic compensation

(75) Inventor: Huagen Guo, Su Zhou City (CN)

Correspondence Address: Richard P. Berg, Esq.;c/o LADAS & PARRY, Suite 2100, 5670 Wilshire Boulevard, Los Angeles, CA, 90036-5679, US

(73) Assignee: BENQ CORPORATION

(21) Appl. No.: 11/046,405

(22) Filed: Jan. 27, 2005

(30) Foreign Application Priority Data
Aug. 26, 2004 (TW) 093125483

(51) Int. Cl. G11B 7/085; G11B 5/09

(52) U.S. Cl. 369/30.03; 369/59.1

(57) ABSTRACT

A method is provided for adjusting a track-seeking compensation coefficient during movement of an optical pick-up unit to a target track position on an optical disk. According to the compensation coefficient to calculate a first number of tracks (T1) to move the pick-up unit in a first orientation. Then, calculate a second number of tracks (T2) for moving the pick-up unit to the target track position in a second orientation. When T2 is larger than a first tolerance, according to the judgment of whether the two orientations are the same, selectively use an upper and lower bounds to adjust the compensation coefficient for next seeking operation. Calculate a third number of tracks (T3) with T1 and T2, and calculate a fourth number of tracks (T4) with the adjusted compensation coefficient. The compensation coefficient may be further adjusted repeatedly until the difference of T3 and T4 is less than a second tolerance.

### BACKGROUND OF THE INVENTION

1. Field of the Invention

The present invention relates to a method for adjusting a track-seeking compensation coefficient, and more particularly, to a method for dynamically adjusting the track-seeking compensation coefficient for controlling an optical pick-up unit of an optical disk drive to seek a target track position on an optical disk.

2. Description of the Prior Art

The track-seeking of a conventional optical disk drive is operated by using a laser beam passing through an objective lens to trace tracks on the optical disk incorporated by moving the optical pick-up unit. There are two common ways to drive the optical pick-up unit, by using the DC motor or the step motor. Movement of the optical pick-up unit to a target track position includes long seek to the proximity of the target track position by moving the optical pick-up unit and short seek to the target track position with tiny movements of the optical pick-up unit and the objective lens. The more precise the long seek is, the less overall seek time it takes.

When the optical pick-up unit is driven by the DC motor, the number of tracks between the current track position on the optical disk where the optical pick-up unit locates and the target track position is calculated first. Such calculation is according to the current track position, the target track position, the condition of the optical disk/disk drive, and a compensation coefficient. The number of tracks calculated represents the distance that the optical pick-up unit needs to cross over. Then, according to the number of tracks calculated, a voltage profile for driving the DC motor is chosen. The voltage profile defines the number of tracks for acceleration and the number of tracks for deceleration. The number of tracks for acceleration represents a certain number of tracks after that the optical pick-up unit reaches its highest speed. The number of tracks for deceleration represents that the optical pick-up unit begins slowing down as a certain number of tracks remains. Accordingly, the optical pick-up unit will perform long seek to move to the proximity of the target track position. Short seek will then be performed.

When the optical pick-up is driven by the step motor, the number of steps for the motor is calculated first. Such calculation is according to the current track position, the target track position, the condition of the optical disk/disk drive, a compensation coefficient, and the track pitch of the optical disk. Then, according to the number of steps calculated, a voltage profile for driving the step motor is chosen. The voltage profile defines the number of steps for acceleration and the number of steps for deceleration. The number of steps for acceleration represents a certain number of steps after that the step motor reaches its highest speed. The number of steps for deceleration represents that the optical pick-up unit begins slowing down as a certain number of steps remains. Accordingly, the optical pick-up unit will perform long seek to move to the proximity of the target track position. Short seek will then be performed.

In the above-mentioned process, the precision of track-seeking is influenced by the following factors. First is the data density. The data density of the optical disk is calculated by the optical disk drive. If the calculated data density is larger than the real data density, it may result in that long seek is not enough; in contrary, long seek may go beyond.

Second is the physical track pitch of the optical disk. The track pitch of the optical disk is defined in the specification known by engineers in the art. For example, the specification track pitch of the compact disk is 1.6 um, and the specification track pitch of the digital versatile disk is 0.74 um. However, the physical track pitch of the optical disk may be different from the specification track pitch, which is defined in the specification. When the physical track pitch of the optical disk is larger than the specification track pitch, it may result in that long seek is not enough; in contrary, long seek may go beyond.

Third is the mechanical friction of related mechanical parts. Strong friction may result in that long seek is not enough. In contrary, long seek may go beyond. Fourth is the torque of the motor. Smaller torque may result in that long seek is not enough; in contrary, long seek may go beyond.

The situation that long seek is not enough or goes beyond will both increase the number of tracks for short seek, resulting in a long overall seek time. To overcome the aforementioned factors, a conventional way is to use a compensation coefficient to enhance the precision of long seek. Consequently, overall seek time can be reduced. In the track-seeking method with compensation according to the prior art, the compensation coefficient is adjusted to enhance the precision of next tracking seeking.

Referring to FIG. 1, FIG. 1 is a flowchart for a track-seeking method with compensation according to a prior art. In the track-seeking method with compensation to seek the target track position according to the prior art, firstly in step S12, a first number of tracks is calculated according to a given compensation coefficient, the current track position on the optical disk where the optical pick-up unit locates, the target track position, and the condition of the optical disk/disk drive. The first number of tracks is the number of tracks for long seek. Then, in step S14, based on the first number of tracks, a voltage profile is generated to drive the optical pick-up unit for long seek.

Then, in step S16, according to the current track position after long seek and the target track position, a second number of tracks is calculated. The second number of tracks is the number of tracks for short seek to be performed later. Then, in step S18, the second number of tracks is compared with a predetermined tolerance. If the second number of tracks is less than the tolerance, then go to step S26 to perform short seek. In step S18, if the second number of tracks is larger than the tolerance, then go to step S20.

In step S20, judge whether the moving orientations of the pick-up unit for long seek and for short seek are the same. If both are not the same orientation, meaning that the first number of tracks for long seek is too large, then go to step S22 to adjust the compensation coefficient by subtracting a predetermined decrement, and then go to step S26 to perform short seek. If both are the same orientation, meaning that the first number of tracks for long seek is too small, then go to step S24 to adjust the compensation coefficient by adding the predetermined increment, and then go to step S26 to perform short seek. The predetermined increment or decrement can be obtained by testing the optical disk drive in advance for different types of optical disk drives.

In the track-seeking method with compensation according to the prior art shown in FIG. 1, the compensation coefficient is predetermined and then adjusted for next long seek. If the compensation coefficient is too large, it easily results in that long seek goes beyond. If the compensation coefficient is too small, it easily results in that long seek is not enough. Therefore, in step S20, the result of judging whether the long seek and short seek are in the same orientation is used for adjusting the compensation coefficient. If both orientations are different, it indicates that long seek goes beyond, so the compensation coefficient needs to be subtracted by the predetermined decrement. If both orientations are the same, it indicates that long seek is not enough, so the compensation coefficient needs to be added by the predetermined increment. In the above mentioned method, every time when adjusting the compensation coefficient, it is to add or subtract the predetermined increment or decrement for once. In other words, the track-seeking method with compensation according to the prior art uses a fixed predetermined increment or decrement to slowly draw near the ideal compensation coefficient. Therefore, it requires track-seeking and compensation coefficient adjustment for many times in order to achieve a precise long seek. Such a method is very time-consuming.

Referring to FIG. 2, FIG. 2 shows a table with the numbers of times needed for adjusting the compensation coefficient in relation to different predetermined increment or decrement according to the method shown in FIG. 1. Take the followings for example to describe that how many times are needed for adjusting the compensation coefficient by using the method according to the prior art shown in FIG. 1. In the example, suppose that before adjusting, the original compensation coefficient is 170 and the ideal compensation coefficient is 195 (which is the ideal coefficient for calculating the ideal number of tracks for long seek); the difference between the original compensation coefficient and the ideal compensation coefficient is 25. Also in the example, suppose that only when the difference between the adjusted compensation coefficient and the ideal compensation coefficient is less than 1, the number of tracks for short seek can be less than a predetermined tolerance.

By using the method according the prior art shown in FIG. 1, the compensation coefficient is adjusted with a fixed predetermined increment or decrement wherein the predetermined increment or decrement influences that how many times are needed for adjusting the compensation coefficient.

By using the method according the prior art in the condition described in the above, the numbers of times required for adjusting the compensation coefficient in relation to different predetermined increment or decrement are listed in the table shown in FIG. 2. In the method according the prior art, the predetermined increment or decrement for adjusting the compensation coefficient usually is not a large number, in order to avoid over adjusting. As a result, the number of times needed for adjusting the compensation coefficient is usually a large number, which means that it requires adjusting for many times which is very time-consuming.

### SUMMARY OF THE INVENTION

It is therefore an objective of the present invention to provide a method for dynamically adjusting a track-seeking compensation coefficient for moving an optical pick-up unit of an optical disk drive from a current track position to a target track position on an optical disk that is installed in the optical disk drive. Using the present invention for track-seeking can reduce the overall seek time.

In an embodiment, an optical disk is installed in an optical disk drive. The track-seeking method with compensation coefficient adjustment according to the present invention can control the optical pick-up unit of the optical disk drive to move to a target track position on the optical disk. In the track-seeking method with compensation coefficient adjustment according to the present invention, first, a first number of tracks (T1) is calculated according to a given first compensation coefficient (K1), a current track position on the optical disk where the optical pick-up unit locates, and the target track position. This calculation can also refer to a condition which comprises a data density of the optical disk or a specification track pitch of the optical disk or both. Based on the first number of tracks (T1), a voltage profile is generated to drive the optical pick-up unit to move in a first orientation, i.e. performing the long seek. After that, a temporary track position where the optical pick-up unit locates is identified. The temporary track position means the track position of the pick-up unit after it performs the long seek and before it performs the short seek. According to the target track position and the temporary track position, a second number of tracks (T2) is calculated. The second number of tracks (T2) will be used for driving the optical pick-up unit to move in a second orientation.

Then, judge if the second number of tracks (T2) is larger than a predetermined first tolerance. If the result is yes, further judge if the first orientation and the second orientation are the same orientation. According to the result of judging the orientation, a second compensation coefficient (K2) is calculated by a first method with a compensation coefficient upper bound or a compensation coefficient lower bound selectively. The second compensation coefficient (K2) is for next track-seeking operation to calculate the number of tracks. Then, based on the second number of tracks (T2), the optical pick-up unit is driven to move in the second orientation to the target track position, i.e. performing the short seek.

Besides, the compensation coefficient can be further adjusted after the initial adjustment as mentioned in the above and before short seek. The followings explain the steps of further adjustment for the compensation coefficient. According to the first number of tracks (T1), the first orientation, the second number of tracks (T2) and the second orientation, a third number of tracks (T3) is calculated. The third number of tracks (T3) is the ideal number of tracks for long seek, which is the ideal number for the first number of tracks (T1). Also, according to the second compensation coefficient (K2), the current track position, the target track position and at least a condition, a fourth number of tracks (T4) is calculated by a second method. The fourth number of tracks (T4) is the calculated number of tracks for long seek if the current long seek is based on the adjusted compensation coefficient. Calculations for the third number of tracks (T3) and the fourth number of tracks (T4) can be done either one first. Both calculations do not have to be in the sequence explained in the above.

Then, judge whether the absolute value of the difference between the fourth number of tracks (T4) and the third number of tracks (T3) is larger than a predetermined second tolerance. If the judgment result is yes, it means that the adjusted compensation coefficient is not good enough; there is still a considerable difference between the calculated number of tracks for long seek according the adjusted compensation coefficient and the ideal number of tracks for long seek. Therefore, repeatedly use the second method to adjust the compensation coefficient until that the difference between the fourth number of tracks (T4) and the third number of tracks (T3) is less than the predetermined second tolerance. If the judgment result is no, it means that the adjusted compensation coefficient is good enough so that difference between the calculated number of tracks for long seek according the adjusted compensation coefficient and the ideal number of tracks for long seek is less than the predetermined second tolerance. After such further adjustment, short seek then can be performed to drive the optical pick-up unit in the second orientation to move to the target track position according to the second number of tracks (T2).

The steps for initial adjustment and further adjustment for the compensation coefficient mentioned in the above are performed before short seek. The adjusted compensation coefficient, however, is used for calculating the number of tracks in next track-seeking; the adjusted compensation coefficient does not affect the current track seeking operation. Therefore, the steps for initial adjustment and further adjustment for the compensation coefficient mentioned in the above can be performed after current short seek. Details will no be mentioned again. Besides, the predetermined first and the second tolerances can be set according to practical situations; both tolerances can be the same or different.

In the track-seeking method with compensation coefficient adjustment according to the present invention, the compensation coefficient, the compensation coefficient upper bound and the compensation coefficient lower bound are dynamically changed and selectively adjusted according to the judgment results during the process. When applying the track-seeking method according to the present invention, only few times of track-seeking are needed to overcome the aforementioned factors to achieve precise long seek, and hence the overall seek time can be reduced.

The advantage and spirit of the invention may be understood by the following recitations together with the appended drawings.

### BRIEF DESCRIPTION OF THE APPENDED DRAWINGS

FIG. 1 is a flowchart for a track-seeking method with compensation according to a prior art.

FIG. 2 shows a table with the numbers of times needed for adjusting the compensation coefficient in relation to different predetermined increment or decrement according to the method shown in FIG. 1.

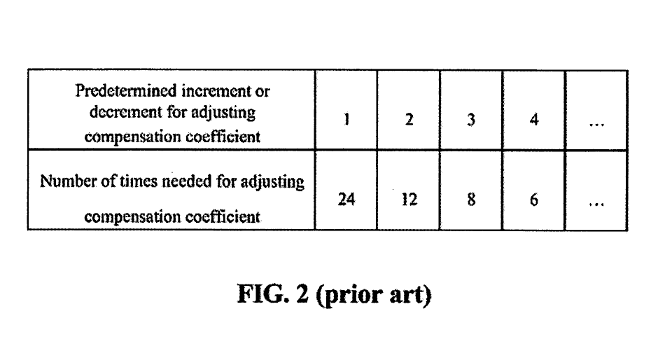

FIG. 3 is a flowchart for a track-seeking method with compensation coefficient adjustment in a preferred embodiment according to the present invention.

FIG. 4 shows a table with the numbers of times for adjusting the compensation coefficient in relation to those dynamically changed compensation coefficient, compensation coefficient upper bound, compensation coefficient lower bound and their adjustments according to the method shown in FIG. 3.

### DETAILED DESCRIPTION OF THE INVENTION

The objective of the present invention is to provide a method for adjusting the track-seeking compensation coefficient, and the purpose is to move an optical pick-up unit of an optical disk drive from a current track position to a target track position on the disk. Therefore, the followings explain the method for adjusting the compensation coefficient. As for how to calculate the number of tracks for track-seeking according to the compensation coefficient and other information, it has been known by those persons skilled in the art; hence it will not be mentioned in details.

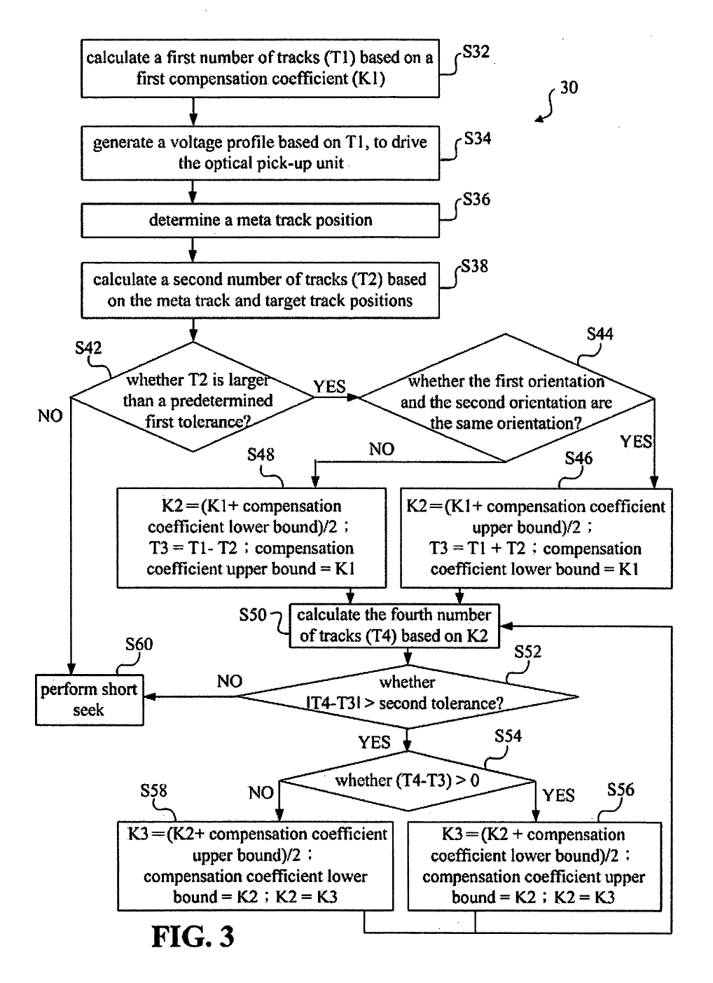

Referring to FIG. 3, FIG. 3 is a flowchart for a track-seeking method with compensation coefficient adjustment in a preferred embodiment according to the present invention. In the preferred embodiment shown in FIG. 3, the flow 30 of the track-seeking method with compensation coefficient adjustment according to the present invention is for controlling an optical pick-up unit of an optical disk drive to move to a target track position on an optical disk. The optical disk is installed in the optical disk drive. The flow 30 of the track-seeking method with compensation coefficient adjustment according to the present invention comprises the following steps.

In step S32, according to a given first compensation coefficient (K1), a current track position on the optical disk where the optical pick-up unit locates, the target track position, and a condition, calculate a first number of tracks (T1). The first number of tracks (T1) is the number of tracks for long seek. The condition may be a data density of the optical disk or the track pitch of the optical disk defined in the specification. In different embodiments, the condition used for calculating the first compensation coefficient (K1) may be any one or more conditions described in the above.

In step S34, based on the first number of tracks (T1), generate a voltage profile to drive the optical pick-up unit to move in a first orientation. Then, go to step S36.

In step S36, identify the track position where the optical pick-up unit locates after the movement in step S34. The track position where the optical pick-up unit locates after the movement is called the temporary track position. That is, the temporary track position means the track position of the pick-up unit after it performs the long seek and before it performs the short seek. Then, go to step S38.

In step S38, according to the target track position and the temporary track position, calculate a second number of tracks (T2). The second number of tracks (T2) represents the number of tracks needed for moving from the temporary track position to the target track position. The second number of tracks (T2) also represents the number of tracks for short seek to be preformed later on. In the short seek to be preformed later, based on the second number of tracks (T2), the optical pick-up unit will be driven to move to the target track position in a second orientation. Then, go to step S42.

In step S42, judge if the second number of tracks (T2) is larger than a predetermined first tolerance. If the second number of tracks (T2) is larger than the first tolerance, then go to perform step S44; if not, then go to perform step S60.

In step S44, judge if the first orientation and the second orientation are the same orientation. If the first orientation and the second orientation are the same orientation, then go to perform step S46; if not, then go to perform step S48. When the first orientation and the second orientation are the same orientation, it means that the first compensation coefficient (K1) is not large enough, so that the first number of tracks (T1) calculated is not enough for long seek, and so that after performing long seek based on the first number of tracks (T1), it is necessary to move the optical pick-up unit in the same orientation during short seek. In such a situation, the compensation coefficient needs to be increased; this can be done by a first method explained in step S46. When the first orientation and the second orientation are the contrary orientations, it means that the first compensation coefficient (K1) is too large, so the first number of tracks (T1) calculated is too large for long seek, and so that after performing long seek based on the first number of tracks (T1), it is necessary to move the optical pick-up unit in the contrary orientation during short seek. In such a situation, the compensation coefficient needs to be decreased; this can be done by the first method explained in step S48.

In step S46, calculate a second compensation coefficient (K2) according to a predetermined compensation coefficient upper bound. The second compensation coefficient (K2) is for next track-seeking operation of the optical pick-up unit. Also, replace a predetermined compensation coefficient lower bound by the first compensation coefficient (K1). Also, calculate a third number of tracks (T3) according to the first number of tracks (T1) and the second number of tracks (T2). In step S46, calculations of the second compensation coefficient (K2) and the third number of tracks (T3) are based on Formula 1 (i.e. the first method when the first orientation and the second orientation are the same orientation) and Formula 2, respectively, described in below. After the second compensation coefficient (K2) and the third number of tracks (T3) are calculated, go to step S50.

Formula 1: K2=(K1+the compensation coefficient upper bound)/2, i.e. the second compensation coefficient=(the first compensation coefficient+the compensation coefficient upper bound)/2. In practice, one can get a weighted average through the calculation of the second compensation coefficient by giving different weightings to the first compensation coefficient (K1) and the compensation coefficient upper bound, respectively. Hereby, calculation for K2 is as K2=[(the first weighting×K1)+(the second weighting×the compensation coefficient upper bound)]/(the first weighting+the second weighting). In this embodiment (as Formula 1), the second compensation coefficient (K2) is calculated by giving the same weightings to the first compensation coefficient and the compensation coefficient upper bound and then taking the average of both.

Formula 2: T3=T1+T2, i.e. the third number of tracks=the first number of tracks+the second number of tracks. It means that in the situation that the original number of tracks for long seek is not large enough, the sum of the original number of tracks for long seek (T1) and number of tracks for short seek (T2) will be the ideal number of tracks for long seek.

In step S48, calculate a second compensation coefficient (K2) according to a predetermined compensation coefficient lower bound. The second compensation coefficient (K2) is for next seeking operation of the optical pick-up unit. Also, replace a predetermined compensation coefficient upper bound by the first compensation coefficient (K1). Also, calculate a third number of tracks (T3) according to the first number of tracks (T1) and the second number of tracks (T2). In step S48, calculations of the second compensation coefficient (K2) and the third number of tracks (T3) are based on Formula 3 (i.e. the first method when the first orientation and the second orientation are the contrary orientations) and Formula 4, respectively, described in below. After the second compensation coefficient (K2) and the third number of tracks (T3) are calculated, go to step S50.

Formula 3: K2=(K1+the compensation coefficient lower bound)/2, i.e. the second compensation coefficient=(the first compensation coefficient+the compensation coefficient lower bound)/2. In practices, one can get a weighted average through the calculation of the second compensation coefficient by giving different weightings to the first compensation coefficient (K1) and the compensation coefficient lower bound, respectively. Hereby, calculation for K2 is as K2=[(the first weighting×K1)+(the second weighting×the compensation coefficient lower bound)]/(the first weighting+the second weighting). In this embodiment (as Formula 3), the second compensation coefficient (K2) is calculated by giving the same weightings to the first compensation coefficient and the compensation coefficient lower bound and then taking the average of both.

Formula 4: T3=T1−T2, i.e. the third number of tracks=the first number of tracks−the second number of tracks. It means that in the situation that the original number of tracks for long seek is too large, the difference between the original number of tracks for long seek (T1) and number of tracks for short seek (T2) will be the ideal number of tracks for long seek.

In step S50, according to the second compensation coefficient (K2), the current track position, the target track position and the at least one condition, calculate a fourth number of tracks (T4). The fourth number of tracks (T4) is the calculated number of tracks for long seek if the current long seek is performed based on the second compensation coefficient (K2) which is the adjusted compensation coefficient. Then, go to step S52.

In step S52, judge whether the absolute value of the difference between the fourth number of tracks (T4) and the third number of tracks (T3) is larger than a predetermined second tolerance. If yes, then go to step S54; if not, go to step S60.

In step S54, judge whether the fourth number of tracks (T4) is larger than the third number of tracks (T3). If yes, go to step S56; it not, go to step S58. When the fourth number of tracks (T4) is larger than the third number of tracks (T3), it means that the second compensation coefficient (K2) is too large, resulting in that the fourth number of tracks (T4) calculated is larger than the ideal number of tracks for long seek (the third number of tracks, T3). In such a situation, the compensation coefficient needs to be decreased; this can be done by a second method to reduce the compensation coefficient, explained in step S56. When the fourth number of tracks (T4) is less than the third number of tracks (T3), it means that the second compensation coefficient (K2) is too small, resulting in that the fourth number of tracks (T4) calculated is less than the ideal number of tracks for long seek (the third number of tracks, T3). In such a situation, the compensation coefficient needs to be increased; this can be done by the second method to enlarge the compensation coefficient, explained in step S58.

In step S56, calculate a third compensation coefficient (K3) based on Formula 5 (i.e. the second method when the fourth number of tracks (T4) is larger than the third number of tracks (T3)), described in below. Also, replace the compensation coefficient upper bound by the second compensation coefficient (K2) and replace the second compensation coefficient (K2) by third compensation coefficient (K3). Then, go back to perform step S50. After the third compensation coefficient (K3) is calculated in step S56, go back to step S50 as a loop. In the loop, the most updated compensation coefficient will be used for the following process. In other words, after the third compensation coefficient (K3) is calculated in step S56, allow K2=K3 and then go back to perform step S50.

Formula 5: K3=(K2+the compensation coefficient lower bound)/2, i.e. the third compensation coefficient=(the second compensation coefficient+the compensation coefficient lower bound)/2. In practices, one can get a weighted average through the calculation of the third compensation coefficient by giving different weightings to the second compensation coefficient (K2) and the compensation coefficient lower bound, respectively. Hereby, calculation for K3 is as K3=[(the third weighting×K2)+(the fourth weighting×the compensation coefficient lower bound]/(the third weighting+the fourth weighting). In this embodiment (as Formula 5), the third compensation coefficient (K3) is calculated by giving the same weightings to the second compensation coefficient (K2) and the compensation coefficient lower bound and then taking the average of both.

In step S58, calculate a third compensation coefficient (K3) based on the Formula 6 (i.e. the second method when the fourth number of tracks (T4) is less than the third number of tracks (T3)), described in below. Also, replace the compensation coefficient lower bound by the second compensation coefficient (K2) and replace the second compensation coefficient (K2) by the third compensation coefficient (K3); then go back to perform step S50. After the third compensation coefficient (K3) is calculated in step S58, go back to step S50 as a loop. In the loop, the most updated compensation coefficient will be used for the following process. In other words, after the third compensation coefficient (K3) is calculated in step S58, allow K2=K3 and then go back to perform step S50.

Formula 6: K3=(K2+the compensation coefficient upper bound)/2, as the third compensation coefficient=(the second compensation coefficient+the compensation coefficient upper bound)/2. In practices, one can get a weighted average through the calculation of the third compensation coefficient by giving different weightings to the second compensation coefficient (K2) and the compensation coefficient upper bound, respectively. Hereby, calculation for K3 is as K3=[(the third weighting×K2)+(the fourth weighting×the compensation coefficient upper bound)/(the third weighting+the fourth weighting). In this embodiment (as Formula 6), the third compensation coefficient (K3) is calculated by giving the same weightings to the second compensation coefficient (K2) and the compensation coefficient upper bound and then taking the average of both.

In step S60, based on the second number of tracks (T2), drive the optical pick-up unit to move to the target track position in the second orientation. This step is to perform short seek to the target track position.

In the track-seeking method with compensation coefficient adjustment according to the present invention, it is to predetermine a compensation coefficient, a compensation coefficient upper bound, a compensation coefficient lower bound, a first tolerance and a second tolerance. In practices, these predetermined compensation coefficient, compensation coefficient upper bound, compensation coefficient lower bound, first tolerance and second tolerance can be obtained by testing different types of optical disk drives. The first and second tolerances can be set as the same or different values.

In the embodiment shown in FIG. 3, from step S44 to S46 or S48, the adjustment of the compensation coefficient is based on the result of judging whether the first orientation for long seek and the second orientation for short seek are the same orientation. In the adjustment, the second compensation coefficient (K2) is calculated selectively by the compensation coefficient upper bound or the compensation coefficient lower bound. The second compensation coefficient (K2) is for next track-seeking operation. The judgment result in step S44 is also for calculating the third number of tracks (T3). The third number of tracks (T3) is the first number of tracks (T1) plus or minus the second number of tracks (T2) that is the number of tracks for short seek to be performed later on. Compared to the first number of tracks (T1), the third number of tracks (T3) is the ideal number of tracks for the long seek which was just performed. Then, in step S50, determine the fourth number of tracks (T4) according to the second compensation coefficient (K2) that is to use the adjusted compensation coefficient to figure out the number of track for the long seek which was just performed. The fourth number of tracks (T4) is for later process.

From the above detailed description, in the track-seeking method with compensation coefficient adjustment according the present invention, the compensation coefficient is adjusted in accordance with the judgment results in the process. Besides, the compensation coefficient upper and lower bounds are changed in accordance with the adjustment of the compensation coefficient; such changed values are used for later process. In the loop of steps S52 to S58, repeatedly perform the steps until the absolute value of the difference between the third and the fourth number of tracks is less than the predetermined second tolerance, and then perform short seek. The adjusted compensation coefficient is for calculating the number of track for next track-seeking; the adjusted compensation coefficient does not work upon the current short seek. Therefore, the steps for adjusting the compensation coefficient mentioned in the above, from step S44 to S56 or S58, can be performed after current short seek, the step S60.

In other words, the compensation coefficient upper and lower bounds are dynamic values in the present invention. Before the initial track-seeking, there are predetermined compensation coefficient upper and lower bounds. When the compensation coefficient is decreased, the compensation coefficient upper bound is changed into the value of the compensation coefficient before adjusting; when the compensation coefficient is increased, the compensation coefficient lower bound is changed into the value of the compensation coefficient before adjusting.

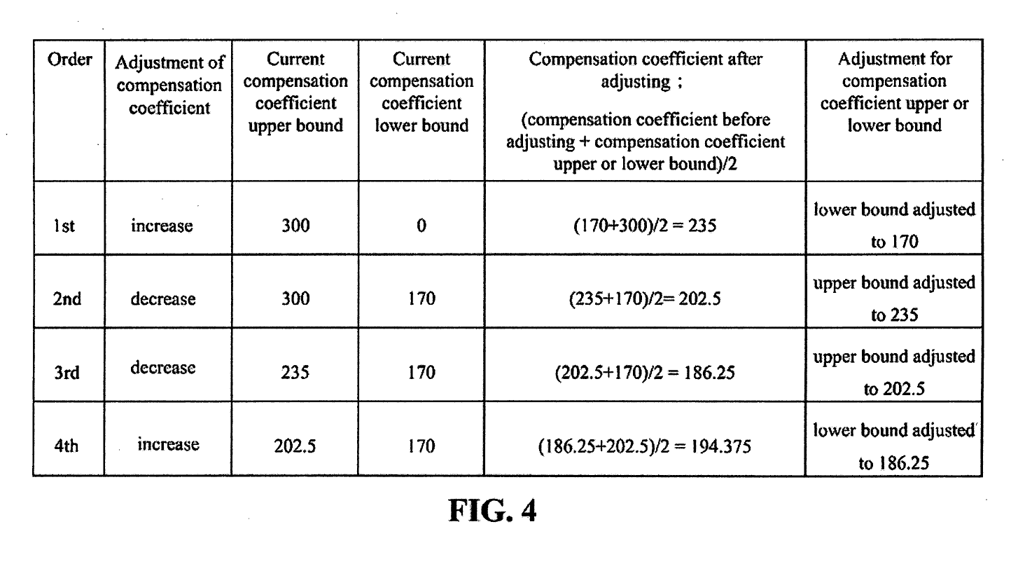

Referring to FIG. 4, FIG. 4 shows a table with the numbers of times for adjusting the compensation coefficient in relation to those dynamically changed compensation coefficient, compensation coefficient upper bound, compensation coefficient lower bound and their adjustments according to the method shown in FIG. 3. We take the followings for example to describe the performance of the methods according to the present invention. In the condition the same as that of the example described in the background of the invention, suppose that before adjusting, the original compensation coefficient is 170 and the ideal compensation coefficient is 195 (i.e. the ideal coefficient for calculating the ideal number of tracks for long seek); the difference between the original compensation coefficient and the ideal compensation coefficient is 25. Also in the example, suppose that only when the difference between the adjusted compensation coefficient and the ideal compensation coefficient is less than 1, the number of tracks for short seek can be less than a predetermined tolerance.

In the example shown in FIG. 4, by using the method for adjusting the track-seeking compensation coefficient according to the present invention, the compensation coefficient upper bound and the compensation coefficient lower bound are predetermined as 300 and 0, respectively. Also when adjusting the compensation coefficient, the first and second weightings of the first method are the same, and the third and fourth weightings of the second method are also the same. By using the method according the present invention and the condition described in the above, the numbers of times required for adjusting the compensation coefficient in relation to those dynamically changed compensation coefficient, compensation coefficient upper bound, compensation coefficient lower bound and their adjustments according to the present invention are listed in the table shown in FIG. 4.

By using the method according the present invention in the condition described in the above, it only needs to adjust the compensation coefficient for 4 times; after that, the different between the compensation coefficient after adjusting and the ideal compensation coefficient is less than 1, which fulfills the requirement for the ideal compensation coefficient.

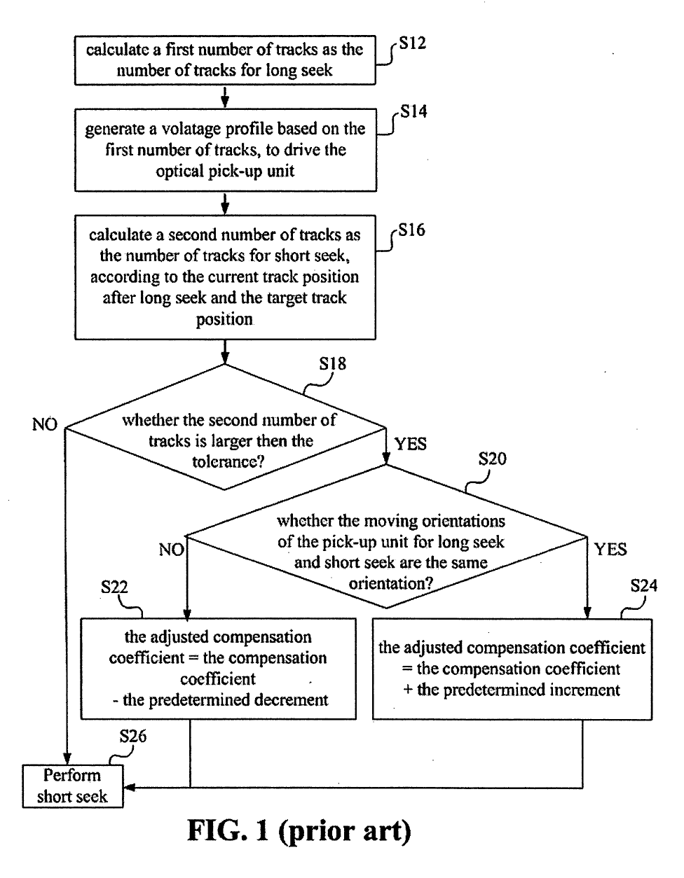

As described in the background of the invention, in the method shown in FIG. 1 according to the prior art, a fixed increment or decrement is used to adjust the compensation coefficient by adding or subtracting the fixed increment or decrement for once during each track-seeking; then the compensation coefficient can be adjusted to slowly draw near the ideal compensation coefficient. The method according to the prior art is very time-consuming. In contrast to the prior art, in the track-seeking method according to the present invention, the compensation coefficient, the compensation coefficient upper bound and the compensation coefficient lower bound are dynamically changed. Those numbers can be selectively adjusted in accordance with the judgment results during the process. Therefore, only few times of track-seeking are needed for overcoming the errors caused by above mentioned reasons to achieve precise long seek, and hence the overall seek time can be reduced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for adjusting a first compensation coefficient during movement of an optical pick-up unit of an optical disk drive from a current track on an optical disk, installed in the optical disk drive, to a target track on the optical disk, said method comprising the steps of:
(a) according to the first compensation coefficient, the current track and the target track, determining a first number of tracks and a first orientation;
(b) according to the first number of tracks and the first orientation, driving the optical pick-up unit to move from the current track to a temporary track;
(c) according to the temporary track and the target track, determining a second number of tracks and a second orientation; and
(d) judging if the second number of tracks is larger than a predetermined first tolerance, and if YES, performing the steps of:
(d-1) judging if the first orientation and the second orientation are the same orientation;
(d-2) according to the result of step (d-1), calculating a second compensation coefficient selectively by an upper bound or a lower bound, selectively adjusting the upper bound or the lower bound by the first compensation coefficient, and adjusting the first compensation coefficient by replacing the first compensation coefficient by the second compensation coefficient.

2. The method of claim 1, wherein in step (a), the first number of tracks and the first orientation also are determined in accordance with at least one condition relative to the optical disk.

3. The method of claim 2, wherein the at least one condition comprises one selected from the group consisting of a data density of the optical disk and a track pitch of the optical disk.

4. The method of claim 1, wherein in step (d-2), when the first orientation and the second orientation are the same orientation, the second compensation coefficient is calculated, according to a predetermined first weighting and a predetermined second weighting, by the following formula:
the second compensation coefficient=[(the first weighting×the first compensation coefficient)+(the second weighting×the upper bound)]/(the first weighting+the second weighting),
and when the first orientation and the second orientation are not the same orientation, the second compensation coefficient is calculated, according to the predetermined first weighting and the predetermined second weighting, by the following formula:
the second compensation coefficient=[(the first weighting×the first compensation coefficient)+(the second weighting×the lower bound)]/(the first weighting+the second weighting).

5. The method of claim 4, wherein the first weighting is equal to the second weighting.

6. The method of claim 1, wherein in step (d-2), when the first orientation and the second orientation are the same orientation, the lower bound is adjusted by replacing the lower bound by the first compensation coefficient, and when the first orientation and the second orientation are not the same orientation, the upper bound is adjusted by replacing the upper bound by the first compensation coefficient.

7. The method of claim 1, wherein in step (d) when the second number of tracks is larger than the first tolerance, said method also comprises the steps of:
(e) determining a third number of tracks in accordance with the first number of tracks, the first orientation, the second number of tracks and the second orientation;
(f) determining a fourth number of tracks in accordance with the second compensation coefficient, the current track and the target track; and
(g) judging if an absolute value of a difference between the fourth number of tracks and the third number of tracks is larger than a predetermined second tolerance, and if YES, performing the steps of:
(g-1) judging if the fourth number of tracks is larger than the third number of tracks;
(g-2) according to the result of step (g-1), calculating a third compensation coefficient selectively by the upper bound or the lower bound, selectively adjusting the upper bound or the lower bound by the second compensation coefficient, replacing the second compensation coefficient by the third compensation coefficient, adjusting the first compensation coefficient again by replacing the first compensation coefficient by the third compensation coefficient; and
(g-3) repeating steps (f) through (g-2) until the result of step (g) is NO.

8. The method of claim 7, wherein in step (e), when the first orientation and the second orientation are the same orientation, the third number of tracks is determined by the following formula:
the third number of tracks=the first number of tracks+the second number of tracks,
and when the first orientation and the second orientation are not the same orientation, the third number of tracks is determined by the following formula:
the third number of tracks=the first number of tracks−the second number of tracks,

9. The method of claim 7, wherein in step (g-2), when the fourth number of tracks is less than the third number of tracks, the third compensation coefficient is calculated, according to a predetermined third weighting and a predetermined fourth weighting, by the following formula:
the third compensation coefficient=[(the third weighting×the second compensation coefficient)+(the fourth weighting×the upper bound)]/(the third weighting+the fourth weighting),
and when the fourth number of tracks is larger than the third number of tracks, the third compensation coefficient is calculated, according to the predetermined third weighting and the predetermined fourth weighting, by the following formula:
the third compensation coefficient=[(the third weighting×the second compensation coefficient)+(the fourth weighting×the lower bound)]/(the third weighting+the fourth weighting).

10. The method of claim 9, wherein the third weighting is equal to the fourth weighting.

11. The method of claim 7, wherein the in step (g-2), when the fourth number of tracks is less than the third number of tracks, the lower bound is adjusted by replacing the lower bound by the second compensation coefficient, and when the fourth number of tracks is larger than the third number of tracks, the upper bound is adjusted by replacing the upper bound by the second compensation coefficient.

12. The method of claim 7, wherein the second tolerance is equal to the first tolerance.
